(19) United States
(12) Patent Application Publication
(10) Pub. No.: US 2009/0187548 A1
(43) Pub. Date: Jul. 23, 2009

(54) SYSTEM AND METHOD FOR AUTOMATICALLY CLASSIFYING SEARCH RESULTS

(75) Inventors: Hyungsuk Ji, Seoul (KR); Hyunseung Choo, Seoul (KR)

Correspondence Address: RATNERPRESTIA, P.O. BOX 980, VALLEY FORGE, PA, 19482, US

(73) Assignee: Sungkyungkwan University Foundation for Corporate Collaboration, Seoul (KR)

(21) Appl. No.: 12/032,819

(22) Filed: Feb. 18, 2008

(30) Foreign Application Priority Data
Jan. 22, 2008 (KR) 10-2008-0006578

(51) Int. Cl. G06F 7/06; G06F 17/30

(52) U.S. Cl. 707/4; 707/E17.017

(57) ABSTRACT

Disclosed is a system and a method for automatically classifying search results. The system includes a search engine server for obtaining and providing search results with regard to a search word entered by the user, grouping the obtained search results according to meanings of the search word, and providing the grouped search results; a related word database for storing related words classified into groups according to meanings of the search word; and a group determination system for receiving search results from the search engine server, comparing the contents of the search results with the related words stored in the related word database to determine which group of the related word database the search results belong to, and storing search results at a predetermined place when the search results are not grouped.

### FIELD OF THE INVENTION

The present invention relates to a system and a method for automatically classifying search results, and more particularly to a system and a method for automatically classifying search results, wherein, in the case of a search word which is ambiguous or which has different meanings depending on the context, reference is made to a related word database storing groups of words related to respective meanings of the search word, the related words are compared with the contents of the search results, the search results are grouped, and the grouped search results are sorted in at least two columns and then outputted.

### BACKGROUND

As generally known in the art, recent development of information technology and widespread use of the Internet have enabled users to easily access a large amount of information. However, when a user has accessed such a large amount of available information, it also includes some pieces of information the user does not want. For these reasons, users have tried to find a way to search desired information only in a fast and efficient manner, and search engines have appeared to satisfy such demands.

In general, search engines refer to search systems employed by users to find information necessary to solve given problems. Search engines are used to conduct searches through the Internet or networks, desktop searches in PC or laptop environments or in other storage spaces, and searches based on mobile devices (e.g. flash memories). In line with the recent development of the Internet, search engines are mainly used to search information through the Internet.

Although no official criterion has been established to classify search engines, they are commonly divided into subject-based search engines and keyword-based search engines according to the operation type.

The subject-based search engines provide a list of categories corresponding to major subjects of information available from the Internet (e.g. society, culture, art, sports, politics). Since they provide a list of various pieces of information corresponding to the subject of interest, the subject-based search engines are also referred to as directory servers, subject-based catalogs, or menu search engines.

The subject-based search engines are advantageous in that, when a user cannot pick a specific subject word or keyword leading to the desired information, he/she can easily access the relevant information. However, this type of access to information requires a number of stages, such as “large category middle category small category desired information.” If an erroneous path is followed in the middle of the search, the user may deviate from the desired information.

In contrast, the keyword-based search engines are advantageous in that only a small number of keywords (search words) are enough to find the desired information quickly. When keywords are entered, a list of search results is provided. However, if the search word is ambiguous or if the search word has different meanings depending on the context, respective meanings are not differentiated, but are intermingled in the search results (lists and excerpts of documents, images, photos, audios, video, flashes, etc.).

It will be assumed for example that, in order to search English contents related to bushes, a user enters “bush” as the search word. Then, a conventional keyword-based search engine will provide a list of contents, in which the search results regarding “Bush” (biographical name) are intermingled with those regarding a “bush” (in the sense of a shrub). In this case, the user will have some difficulty in finding the desired contents.

Furthermore, when the entered search word is ambiguous or has different meanings depending on the context, and when some of the different meanings of the search word occupy the majority of top-ranking contents of the search results, the user must review almost all search results until he/she reaches the desired contents that are ranked very low. This is unfavorable in terms of both time and efficiency.

In short, conventional keyword-based search engines have a problem in that, when the search word is ambiguous or has different meanings depending on the context, the different meanings are intermingled with one another in the search results. As a result, the user must spend considerable time and energy until he/she finds the desired information.

### SUMMARY OF THE INVENTION

Accordingly, the present invention has been made to solve the above-mentioned problems occurring in the prior art, and the present invention provides a system and a method for automatically classifying search results so that, when a search word entered to a search engine adopting a conventional keyword-based search method is ambiguous or has different meanings depending on the context, the problem of intermingling of different meanings in the search results is avoided.

The present invention also provides a system and a method for automatically classifying search results so that, when a search word entered to a search engine adopting a conventional keyword-based search method is ambiguous or has different meanings depending on the context, the problem of intermingling of different meanings in the search results is avoided, thereby guaranteeing that the user can find the desired information quickly and efficiently.

In accordance with an aspect of the present invention, there is provided a system for automatically classifying search results, the system including a search engine server 10 for obtaining and providing search results 50 with regard to a search word entered by a user, receiving grouped search results 50, and providing the user with the grouped search results 50; a related word database 20 for storing related words classified into groups according to meanings of the search word; and a group determination system 30 for receiving search results 50 from the search engine server 10, comparing the search results 50 with the related words stored in the related word database 20 to determine which group of the related word database 20 the search results 50 belong to, providing the search engine server 10 with grouped search results 50, and storing search results 50 at a predetermined place when the search results 50 are not grouped which means that either the search results 50 are belong to no group of the related word database 20 or the search results 50 belong to all of the groups.

Preferably, the system further includes a category determination system 40 for classifying the search results 50 stored at the predetermined place without being grouped by the group determination system 30 according to domain names providing the search results 50.

Preferably, the search engine server 10 includes a search result query processor for querying the group determination system 30 regarding which group the search results 50 corresponding to the search word entered by the user belong to.

Preferably, the group determination system 30 includes a count processor for counting how many related words stored in a plurality of groups constituting the related word database 20 are contained in contents of the search results group by group; a group allocation processor for determining which group of the related word database 20 the search results belong to according to a number counted by the count processor; and a non-group allocation processor for identifying search results 50 not being grouped and storing the identified search results 50 at a predetermined place.

Preferably, the group determination system 30 includes a count processor for counting how many related words stored in a plurality of groups constituting the related word database 20 are contained in contents of the search results 50 group by group; an intelligent group decision processor for assigning weights to respective related words stored in the related word database 20 according to a degree of correlation between the related words and meanings of the search word; a group allocation processor for combining the weights assigned to the related words by the intelligent group decision processor with numbers counted by the count processor to determine which group of the related word database 20 the search results 50 belong to; and a non-group allocation processor for identifying search results 50 not being grouped and storing the identified search results 50 at a predetermined place.

Preferably, the category determination system 40 includes a domain group database for storing domain names classified hierarchically into at least two groups; and a category-based search result allocation processor for classifying the search results 50 by determining which group of the domain group database a host belongs to according to a domain name of the host, the host having provided the search results.

Preferably, the system further includes a user preference acceptance system for enabling the user to set the number of columns, the grouped search results 50 being outputted in the columns, and redisplaying the search results according to the user setting or displaying next search results 50 according to the user setting; and an initial column number update system for statistically surveying user preferences regarding the number of groups, the search results being classified into the groups, and automatically updating an initial setting according to the user preferences.

In accordance with another aspect of the present invention, there is provided a method for automatically classifying search results with reference to a related word database storing groups of words related to a search word, the method including the steps of (a) receiving a search word entered by a user (S10); (b) obtaining search results with regard to the entered search word (S20); (c) grouping the search results by a group determination system with reference to the related word database (S30, S40); and (d) sorting and providing the grouped search results in at least two groups (S50).

Preferably, in step (c) (S30, S40), weights are assigned to respective related words belonging to each group of the related word database according to a degree of correlation between the related words and meanings of the search word, each weight is combined with a number of appearance of the related word in the search results, and the search results are allocated to a group having a high combined weight.

Preferably, the method further includes a step of (e) repeating steps (c) and (d) when the user wants to divide some groups of the grouped, outputted search results into subgroups and terminating searches when the user does not want to divide some groups of the grouped, outputted search results into subgroups.

Preferably, the method further includes a step of (f) classifying the search results according to a group of a domain group database, a domain name providing the search results belonging to the group, by a category determination system when it is considered impossible to group the search results by the group determination system, and outputting the classified search results.

The system and method for automatically classifying search results according to the present invention are advantageous as follows: search results are grouped with reference to the related word database, which stores related words grouped according to the meaning or usage of the search word, so that the results are separately provided according to the meaning and field of interest. As a result, the user can access desired search results more quickly and accurately.

The system and method selectively employ the group determination system, which compares search results with the related word database and groups the search results accordingly, or the category determination system, which groups the search results based on the domain name of the host of the search results, so that, even if search results are not grouped by the group determination system, they can be grouped by the category determination system. This substantially improves the convenience and efficiency of searching.

### BRIEF DESCRIPTION OF THE DRAWINGS

The above and other objects, features, and advantages of the present invention will be more apparent from the following detailed description taken in conjunction with the accompanying drawings, in which:

FIG. 1 shows the overall construction of a system for automatically classifying search results according to the present invention;

FIG. 2 is a flowchart showing a method for automatically classifying search results according to the present invention;

FIG. 3 shows a process for grouping search results by a system for automatically classifying search results according to the present invention; and

FIG. 4 shows an exemplary screenshot when a system for automatically classifying search results according to the present invention has been applied.

### DETAILED DESCRIPTION OF THE EXEMPLARY EMBODIMENTS

Hereinafter, an exemplary embodiment of the present invention will be described with reference to the accompanying drawings. In the following description and drawings, the same reference numerals are used to designate the same or similar components, and so repetition of the description on the same or similar components will be omitted.

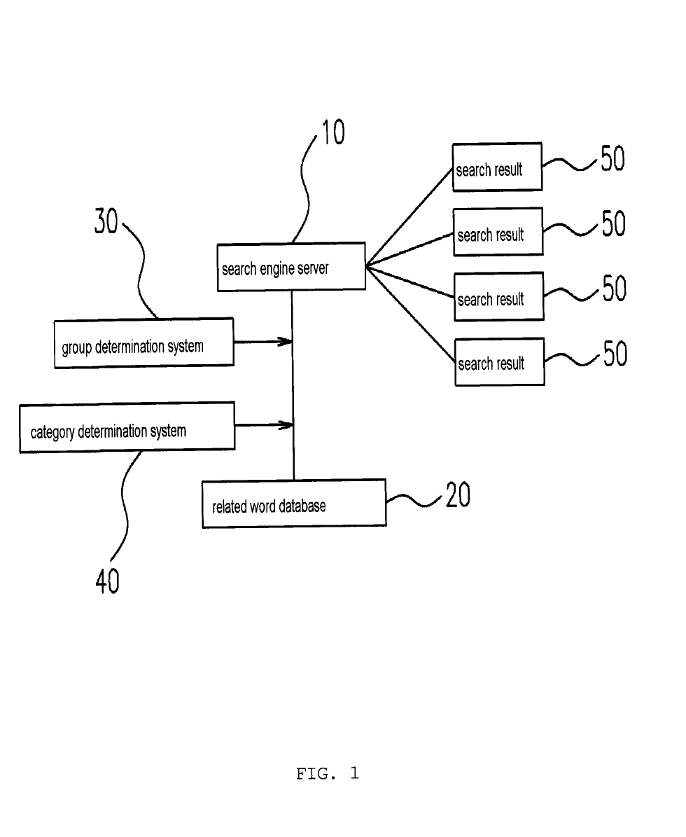

FIG. 1 shows the overall construction of a system for automatically classifying search results according to the present invention.

Referring to FIG. 1, the system for automatically classifying search results according to the present invention includes a search engine server 10 for receiving a search word entered by the user, providing the user with obtained search results 50, receiving an input of grouped search results 50, and providing the user with the grouped search results 50; a related word database 20 for storing groups of words related to respective meanings of search words; and a group determination system 30 for receiving search results 50 from the search engine server 10, comparing the search results 50 with the related words stored in the related word database 20 to determine which group of the related word database 20 the search results 50 belong to, providing the search engine server 10 with the grouped search results 50, and storing the search results 50 at a specific place when the search results 50 do not belong to any group of the related word database 20.

The search engine server 10 according to the present invention obtains and provides search results 50 with regard to keyword searches using the Internet, personal computers, networking computers, or other available online/offline search devices. In addition, the search engine server 10 receives an input of grouped search results 50 and displays them or outputs them as audible signals (e.g. voices, sounds).

The search engine server 10 according to the present invention refers to a search engine server adapted to output search results using any type of search device, including a search engine server adapted to output results with regard to keyword searches of Internet users, a search engine server adapted to output results with regard to desktop keyword searches (desktop, local, neighboring, wideband network, etc.) of computer users, and a universal search engine server adapted to output results with regard to keyword searches using mobile search devices (e.g. flash memories).

The search engine server 10 according to the present invention includes a search result query processor for querying the group determination system 30 about search results 50. The search result query processor is adapted to query the group determination system 30 about search results 50, in which different meanings of search words are intermingled.

The related word database 20 according to the present invention stores groups of related words, which have been classified according to the meaning of search words based on consideration of the correlation between the frequency of appearance of words in web pages or offline corpus and the meaning of search words.

The related word database 20 according to the present invention stores groups of words related to respective meanings of search words, which are ambiguous or have different meanings depending on the context. The groups of the related word database 20, which have been classified according to the meaning of search words, can be further divided into subgroups according to the extent to which the meanings of search words are correlated.

Particularly, a hierarchical clustering method is used to divide the related word database 20 into subgroups. According to this method, if the related word database has two groups, each group is further divided into subgroups. This subdivision may be based on a distance calculation method, which combines related words having close meanings into one. However, this degrades the speed.

Therefore, a number of related word databases 20 having different numbers of groups with regard to a single initial search word are preferably established so that the user can select a related word database 20 having the desired number of groups. This is favorable in terms of speed.

The system for automatically classifying search results according to the present invention employs a related word database 20, which is provided by the system provider, to classify search results 50. The detailed process or method for dividing the related word database 20 into a number of groups lies out of the scope of the present invention, and descriptions thereof will be omitted herein.

The group determination system 30 according to the present invention compares the contents of search results 50 resulting from an entered search word with related words to determine which group of related words the search results 50 belong to. As used herein, the contents of search results 50 refer to a set of words within the search results resulting from a keyword search on the web.

The group determination system 30 according to the present invention includes a count processor for counting the number of related words, which are both stored in the groups constituting the related word database 20 and included in the contents of search results 50 resulting from an entered search word, a group allocation processor for determining which group of the related word database the search results 50 belong to based on the number counted by the count processor, and a non-group allocation processor for recognizing search results, which are not grouped, and storing the search results 50 at a predetermined place.

Preferably, the group determination system 30 according to the present invention further includes an intelligent group decision processor for assigning weights to respective related words stored in the related word database 20 according to the degree of correlation between their meaning and that of search words. In this case, the weights assigned to respective related words by the intelligent group decision processor are combined with the number counted by the count processor to determine which group the research results 50 belong to. This process efficiently groups the search results 50.

The group determination system 30 according to the present invention can group most search results. However, if it is considered meaningless or impossible to group some search results by the group determination system 30, a category determination system 40 may be used to classify the search results.

The category determination system 40 according to the present invention determines the category of search results 50 based on the domain name of the search results, when the group determination system 30 determines that it is meaningless or impossible to group the search results by the non-group allocation processor.

The category determination system 40 according to the present invention groups the contents of search results 50 independently of the group determination system 30. The category determination system 40 includes a domain group database storing at least two groups of domain names of Internet hosts, which have been classified hierarchically, and a category-based search result allocation processor for classifying search results by determining which group of the domain group database the host, which has provided the search results 50, belongs to based on the domain name of the host.

The system for automatically classifying search results according to the present invention may include a user preference acceptance system for allowing the user to set the number of columns, in which grouped search results are outputted, and reflecting the setting to redisplay the search results or reflecting the setting to display the next search results, and an initial column number update system for statistically surveying user preferences regarding the number of groups, into which search results are classified, and automatically updating the initial setting based on the user preferences.

When the user designates the desired number of groups and starts a search, the user preference acceptance system according to the present invention refers to a related word database 20, which has the same number of groups as the user setting, and outputs the search results 50 based on the same number of groups.

The initial column number update system according to the present invention statistically surveys user preferences regarding the number of groups, and automatically updates the initial setting of the number of groups into which search results 50 are classified. Therefore, the user of the system for automatically classifying search results according to the present invention does not have to enter the desired group number for every search, since the system refers to the cookie, for example, and automatically classifies the search results 50 into groups, the number of which is favored by the user. This is the same case as the user of Google Search who can determine the desired number of results to be displayed per page (e.g. 10, 30, or 100 results per page) in the “Preferences” menu.

It can be said that the system for automatically classifying search results according to the present invention secondarily groups search results 50 obtained by search results 10 in various manners. Therefore, the system can be operated independently of the search mode of the search engines 10. Those skilled in the art can also easily understand that the system can be interlinked with and operated together with a search engine 10 when the search engine 10 composes a search word index table, i.e. when the search engine 10 conventionally composes a search table regarding search words before users enter search words and start the search process.

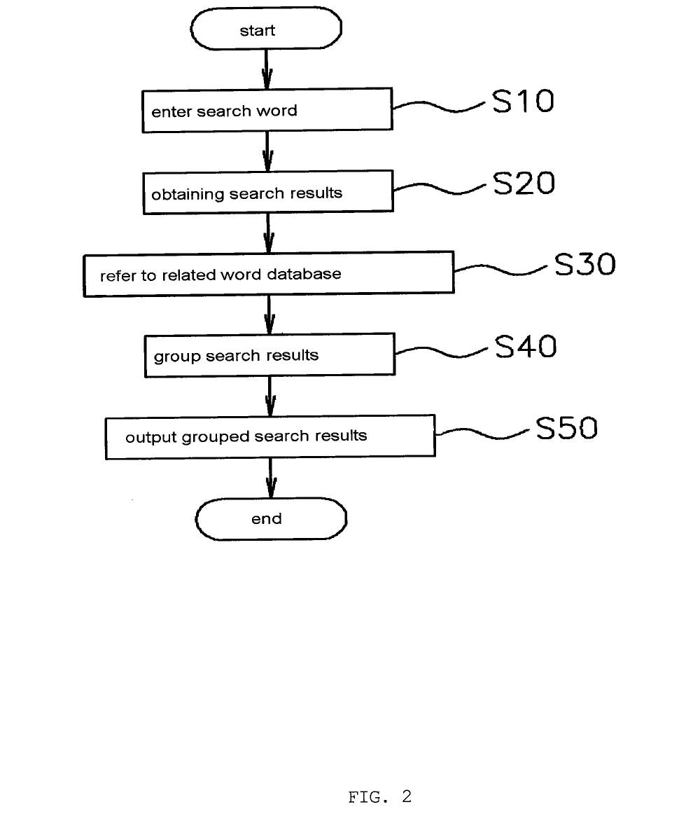

FIG. 2 is a flowchart showing a method for automatically classifying search results according to the present invention.

Referring to FIG. 2, the method for automatically classifying search results according to the present invention refers to the related word database table, which stores groups of words related to search words, and classifies search results accordingly. The method includes a first step (S10) of receiving a search word entered by the user, a second step (S20) of obtaining search results with regard to the entered search word, a third step (S30 and S40) of referring to the related word database and grouping the search results by the group determination system, and a fourth step (S50) of sorting the grouped search results in at least two columns and providing them.

More particularly, when the user enters a search word corresponding to desired information (S10), search results are obtained with regard to the entered search word without classifying them according to the meaning or usage of the search word (S20). After the search results are obtained by the search engine server, the search engine server provides the group determination system with the obtained search results. The group determination system then refers to the related word database, which stores groups of related words according to the meaning of search words (S30), and groups the search results. The search engine server is provided with the grouped search results, which are outputted as video signals or audio signals (e.g. voices, sounds) (S50).

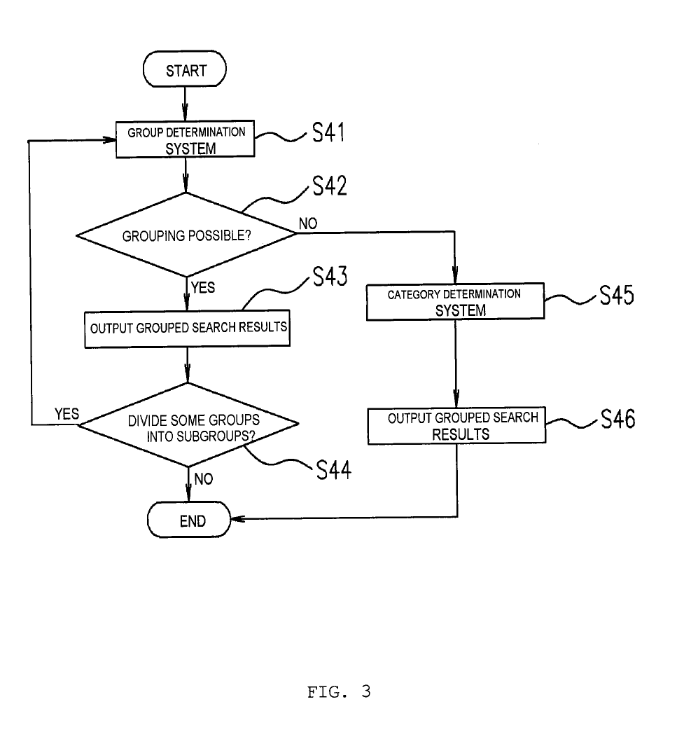

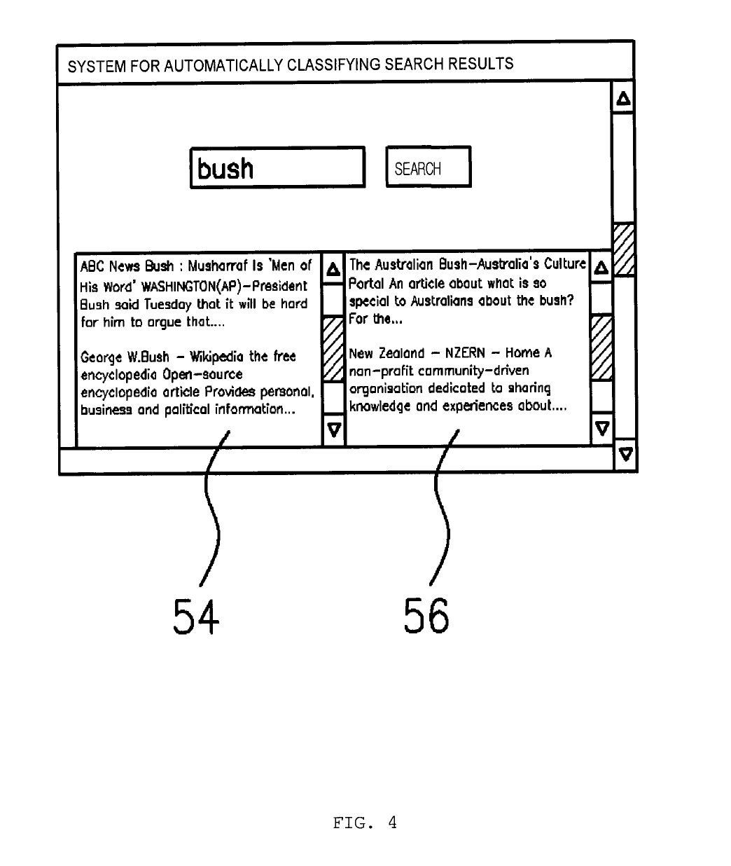

The process for referring to the related word database to group the search results and the process for outputting the grouped search results as video signals or audio signals (e.g. voices, sounds) will now be described in more detail with reference to FIGS. 3 and 4.

FIG. 3 shows a process for grouping search results by a system for automatically classifying search results according to the present invention.

Referring to FIG. 3, the process for grouping search results by a system for automatically classifying search results according to the present invention proceeds as follows: it is primarily determined to group the search results by the group determination system (S41) with reference to the related word database, which stores groups of related words (S42). The grouped search results are then outputted (S43). If the group determination system cannot group the search results, the category determination system (S45) secondarily groups the search results based on the domain name of the host of the search results and outputs them.

If the user wants to divide some groups of the grouped search results into subgroups (S44), it is determined again if the group determination system (S41) can subdivide the groups. When the group determination system can subdivide the groups, the subdivided search results are outputted (S43). When the group determination system cannot subdivide the groups, the category determination system (S45) divides some groups of the search results into subgroups and outputs them (S46).

The system for automatically classifying search results according to the present invention primarily uses the group determination system (S41) to compare the related word database, which stores groups of related words, with the contents of search results and determine if grouping is possible (S42).

For example, when the user enters “bush” as the search word and starts a search, words related to the “bush” are obtained as follows:

George, Mr, tree, rose, administration, Clinton, trees, green, grass, ground, Bill, wild, low, campaign, leaves, p., thick, bird, congress, road, thorn, meeting, beating, covered, USA, rock, visit, camp, beat, birds, garden, shepherd, growing, announced, summit, Gorbachev, Iraq, talks, hill, June, republican, yards, flowers, cattle, branches, burning, forest, Reagan, dense, edge, presidential, Moses, fruit, plant, dry, Nov., July, decision, address.

The related word database is divided into a number of groups according to the meaning of the search word. Assuming that the related word database is divided into two groups with regard to the ambiguous search word “bush,” the first group contains words related to “Bush” as a biographical name, and the second group contains words related to the “bush” in the sense of a shrub. More particularly, the related word database is grouped as follows:

First group: Reagan, summit, bush, Moses, address, George, Bill, meeting, Mr, visit, Iraq, USA, campaign, June, talks, announced, decision, July, Nov., p., congress, Gorbachev, Clinton, presidential, administration, republican; and

Second group: tree, rose, trees, green, grass, ground, wild, low, leaves, thick, bird, road, thorn, beating, covered, rock, camp, beat, birds, garden, shepherd, growing, hill, yards, flowers, cattle, branches, burning, forest, dense, edge, fruit, plant, dry.

The group determination system according to the present invention determines which of the first and second groups of the related word database has more words related to the contents of search results.

If it is determined that only one of the groups of the related word database has words related to the contents of search results, the group determination system considers that the contents of search results belong to the corresponding group. For example, if the contents of search results have no related words belonging to the first group, but only those belonging to the second group, the group determination system considers that the contents of search results belong to the second group.

If the contents of search results have related words simultaneously belonging to at least two groups of the related word database, the group determination system groups the search results based on consideration of the number of appearance of related words belonging to respective groups in the contents of search results together with the priority of the related words.

More particularly, the group determination system according to the present invention counts the number of appearance of related words, which belong to the first group, in the contents of search results, and that of related words belonging to the second group by using the count processor. The counted numbers are compared to determine the group having more related words appearing in the contents of search results. The contents of search results are considered belonging to the determined group.

In addition, the group determination system according to the present invention can assign weights to respective related words belonging to each group for calculation and determination. Particularly, the intelligent group decision processor of the group determination system assigns weights to respective related words belonging to each group of the related word database according to the degree of correlation between their meaning and that of search words for decision.

Assuming for example that words which are related to the above-mentioned search word “bush” and which belong to the first group of the related word database are arranged in a multi-dimensional space according to the degree of correlation with the biographical name “Bush”, closely related words are arranged at the center of gravity, while those with little correlation are far from the center.

Particularly, if a related word “Reagan” is located near the center of gravity of the meaning of related words of the first group while a related words “republican” is far from the center, the related word “Reagan” is given a weight because it is more likely to belong to the first group.

In addition, if the related word database has groups classified according to the meaning or usage of search words and if the groups lie adjacent to one another, some related words may be located near boundaries far from the center of gravity of the meaning of respective groups. Such related words make little contributions to grouping, and thus are given very low weights.

Preferably, the group determination system considers both the number of appearance of related words belonging to each group in the contents of search results and the weights assigned to them based on the meaning when making a decision. In other words, the weight of related words is combined with the number of appearance in the contents of search results, and the contents of search results are considered belonging to the group having the highest total weight. Such consideration of both the number of appearance and the weight of related words guarantees that the contents of search results are grouped in a more precise manner.

The group determination system according to the present invention determines which group the search results belong by using the count processor and the intelligent group decision processor. The group determination system groups the search results by using the group allocation processor or the non-group allocation processor, and provides the search engine server with the grouped search results.

When the contents of search results belonging to a specific group of the related word database, the group allocation processor according to the present invention allocates the search results to the corresponding group. When the contents of search results is not grouped, the non-group allocation processor stores the search results at a predetermined place. The search results stored at the predetermined place by the non-group allocation processor are grouped by the category determination system (described later). Alternatively, the search results that have not been grouped may be outputted as a single group according to user selection.

When the group determination system cannot clearly determine the group to which the search results belong because the search results are at the boundary of both groups, the search results are displayed to both groups. The order of displaying the search results are different between both groups according to the priority decided by the group determination system.

The search results grouped by the group determination system according to the present invention are displayed and outputted (S43) in at least two columns by an output device (e.g. monitor). In the case of the above-mentioned example, search results related to the biographical name “Bush” may be displayed in the left column, and search results related to the “bush” in the sense of a shrub may be displayed in the right column. When the search device and search server are adapted to provide search results audibly, not visually, the search results belonging to respective groups are provided as separate audio signals.

Although it has been assumed in the above exemplary description that the related word database is divided into two groups with regard to the search word “bush” entered by the user, the user can arbitrarily set the number of groups of the related word database. In this case, respective groups of the related word database are divided into subgroups so that search results are divided into the number of groups selected by the user.

When the user wants to divide some groups of the grouped search results into subgroups (S44), the system for automatically classifying search results according to the present invention determines if the group determination system (S41) can again subdivide the groups.

The related word database has a number of groups classified according to the meaning of search words, and respective groups are adapted to be divided into subgroups according to the degree of correlation of related words in terms of their meaning. Therefore, when the user wants to divide some groups of the grouped search results into subgroups, it is determined if the related words belonging to the corresponding groups of the related word database can be grouped by the group determination system based on the related word database, which has again been divided into subgroups.

When some groups of the grouped search results can be divided into subgroups by the group determination system, the groups are divided into subgroups, and the corresponding search results are outputted. When it is determined meaningless or impossible to divide the groups into subgroups by the group determination system, the category determination system (S45) secondarily divides some groups of the search results into subgroups.

When it has been determined meaningless or impossible to group the search results by the group determination system, and when the system for automatically classifying search results according to the present invention has been notified (S42) of the meaningless of grouping by the non-group allocation processor, the category determination system (S45) may secondarily group the search results.

The category determination system according to the present invention includes a domain group database storing at least two groups of domain names, which have been classified hierarchically. For example, the domain group database has a first group of domain names, such as “.com” and “.biz”, and a second group of domain names, such as “.edu” and “.org”.

The category determination system according to the present invention may refer to a database, which stores categorized domain names, to classify the contents of search results by using the category groups. For example, the category determination system refers to a categorized database, which stores “http://www.nytimes.com” in the news site category, “http://www.nature.com/nature” in the journal category, etc., to classify the search results.

The category determination system according to the present invention can group the search results and separately output them (S46) by the category-based search result allocation processor for classifying the search results by determining which group of the domain group database the host, which has provided the search results, belongs to based on the domain name of the host.

FIG. 4 shows an exemplary screenshot when a system for automatically classifying search results according to the present invention has been applied.

Referring to FIG. 4, the system for automatically classifying search results according to the present invention outputs search results, which have been grouped by the group determination system and the category determination system, in at least two columns 54 and 56.

The search results grouped by the system for automatically classifying search results according to the present invention are displayed by an output device (e.g. monitor) in at least two columns. For example, the first search results 54 related to the biographical name “Bush” in the above-mentioned example are displayed in the left column, and the second search results 56 related to the “bush” in the sense of a shrub are displayed in the right column. When the search device and search server are adapted to provide search results audibly, not visually, the search results belonging to respective groups are provided as separate audio signals.

Those skilled in the art can easily understand that, although FIG. 4 shows search results displayed in at least two columns, the search results can be displayed in any manner as long as the search results can be recognized group by group. For example, the search results may be displayed in rows. Alternatively, the search results may be displayed in respective sections of the interior of a circle (i.e. in a pie type) or any other closed loop.

In addition, although it has been assumed in the description with reference to FIG. 4 that the search results are divided into two groups, the search results may be divided into at least three groups and outputted when the related word database has at least three groups or when the search results classified by the group determination system are again classified into subgroups.

As mentioned above, the system for automatically classifying search results according to the present invention is advantageous in that search results are grouped with regard to a search word, which is ambiguous or which has different meanings depending on the context, and are outputted accordingly so that the user can not only conduct a search easily, but also efficiently find the desired information from the search results.

To be more specific, when one of the leading search engines conducts a search with regard to the above-mentioned search word “bush”, search results related to the “bush” in the sense of a shrub occupy no more than two of the upper 200 results, and the remaining 198 search results are related to the biographical name “Bush”. This means that, if the user wants to find search results related to the “bush” in the sense of a shrub, he/she must waste considerable time and energy to find just two results from 200 results.

In contrast, the system for automatically classifying search results according to the present invention groups search results according to the meaning or usage of the search word and outputs the search results in two, three, or at least four columns so that the user can easily find the group to which the desired search results belong. This substantially reduces the time and energy necessary for searching.

Such an intelligent and efficient search engine is also favorable to search engine business providers. If the desired search results are not ranked high, users will have difficulty in finding them and get disappointed. In contrast, if search results are grouped and displayed separately so that users can easily find the desired search results, the competitiveness of the search engine business provider will be substantially improved.

Furthermore, if a search word regarding a product, which is advertised on the web, is ambiguous or has different meanings depending on the context, the search results provided by conventional search engines with regard to the product tend to be ranked low among the entire search results. This means that the search results are less likely to be viewed by users. If the system for automatically classifying search results according to the present invention is employed in this regard, search results are grouped according to the meaning or usage of the search word and are outputted group by group so that the users can easily access the search results regarding the advertiser's product.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A system for automatically classifying search results, the system comprising:
a search engine server for obtaining and providing search results with regard to a search word entered by a user, receiving grouped search results, and providing the user with the grouped search results;
a related word database for storing related words classified into at least two groups according to meanings of the search word; and
a group determination system for receiving search results from the search engine server, comparing the search results with the related words stored in the related word database to determine which group of the related word database the search results belong to, providing the search engine server with grouped search results, and storing search results at a predetermined place when the search results are not grouped.

2. The system as claimed in claim 1, further comprising a category determination system for classifying the search results stored at the predetermined place without being grouped by the group determination system according to domain names providing the search results.

3. The system as claimed in claim 1, wherein the search engine server comprises a search result query processor for querying the group determination system regarding which group the search results corresponding to the search word entered by the user belong to.

4. The system as claimed in claim 1, wherein the group determination system comprises:
a count processor for counting how many related words stored in a plurality of groups constituting the related word database are contained in contents of the search results group by group;
a group allocation processor for determining which group of the related word database the search results belong to according to a number counted by the count processor; and
a non-group allocation processor for identifying search results not being grouped and storing the identified search results at a predetermined place.

5. The system as claimed in claim 1, wherein the group determination system comprises:
a count processor for counting how many related words stored in a plurality of groups constituting the related word database are contained in contents of the search results group by group;
an intelligent group decision processor for assigning weights to respective related words stored in the related word database according to a degree of correlation between the related words and meanings of the search word;
a group allocation processor for combining the weights assigned to the related words by the intelligent group decision processor with numbers counted by the count processor to determine which group of the related word database the search results belong to; and
a non-group allocation processor for identifying search results not being grouped and storing the identified search results at a predetermined place.

6. The system as claimed in claim 2, wherein the category determination system comprises:
a domain group database for storing domain names classified hierarchically into at least two groups; and
a category-based search result allocation processor for classifying the search results by determining which group of the domain group database a host belongs to according to a domain name of the host, the host having provided the search results.

7. The system as claimed in claim 1, further comprising:
a user preference acceptance system for enabling the user to set the number of columns, the grouped search results being outputted in the columns, and redisplaying the search results according to the user setting or displaying next search results according to the user setting; and
an initial column number update system for statistically surveying user preferences regarding the number of groups, the search results being classified into the groups, and automatically updating an initial setting according to the user preferences.

8. A method for automatically classifying search results with reference to a related word database storing groups of words related to a search word, the method comprising the steps of:
(a) receiving a search word entered by a user;
(b) obtaining search results with regard to the entered search word;
(c) grouping the search results by a group determination system with reference to the related word database; and
(d) sorting and providing the grouped search results in at least two groups.

9. The method as claimed in claim 8, wherein, in step (c), weights are assigned to respective related words belonging to each group of the related word database according to a degree of correlation between the related words and meanings of the search word, each weight is combined with a number of appearance of the related word in the search results, and the search results are allocated to a group having a high combined weight.

10. The method as claimed in claim 8, further comprising a step of (e) repeating steps (c) and (d) when the user wants to divide some groups of the grouped, outputted search results into subgroups and terminating searches when the user does not want to divide some groups of the grouped, outputted search results into subgroups.

11. The method as claimed in claim 10, further comprising a step of (f) classifying the search results according to a group of a domain group database, a domain name providing the search results belonging to the group, by a category-determination system when it is considered impossible to group the search results by the group determination system, and outputting the classified search results.
